(19) United States
(12) Patent Application Publication
(10) Pub. No.: US 2015/0196155 A1
(43) Pub. Date: Jul. 16, 2015

(54) Sausage and Bun Packaging System and Method

(71) Applicant: Johnsonville Sausage, LLC, Sheboygan Falls, WI (US)

(72) Inventors: Tyler Green, Appleton, WI (US); Gene Rech, Cedarburg, WI (US)

(21) Appl. No.: 14/595,661

(22) Filed: Jan. 13, 2015

Related U.S. Application Data
(60) Provisional application No. 61/926,748, filed on Jan. 13, 2014.

(51) Int. Cl. A47J 27/04; B65D 85/00

(52) U.S. Cl. CPC A47J 27/04; B65D 85/70; A47J 2027/043

(57) ABSTRACT

A food container includes a base having a bottom wall and defining a longitudinal axis. A cover covers the base above the bottom wall. At least two bun supports on opposite sides of the longitudinal axis are provided and define a space therebetween for receiving an elongated food item substantially parallel to the longitudinal axis. The bun supports can support a bun above the elongated food item.

### CROSS REFERENCES TO RELATED APPLICATIONS

This application claims the benefit of the filing date of U.S. Provisional Patent Application No. 61/926,748 filed Jan. 13, 2014, which is hereby incorporated by reference for all purposes as if set forth in its entirety herein.

### STATEMENT REGARDING FEDERALLY SPONSORED RESEARCH

Not applicable.

### BACKGROUND OF INVENTION

Food containers used for packaging a sausage and bun, for example, in the food service industry are known in the art. Electric steamer devices are often used to treat bread and bread-type products, such as sausage buns, prior to being served. When steam impregnates a bread-type food product, the steam tends to soften the bread product to make the bread product seem fresher.

Conventional steamers include both boiler-type steamers as well as flash steamers in which a volume of water is deposited or sprayed onto a hot surface, which “flashes” or converts the water to steam. A small, fixed amount of water is delivered onto a hot dry surface which causes the water to be quickly boiled off and turned into steam. However, these steamers and flash steamers require additional time and costs for preparing and serving a sausage on a fresh, steamed bun. Often, in the food service industry, the time required to prepare and serve the sausage and steamed bun must be minimized in order to serve the maximum number of customers. Thus, many businesses in the food service industry have avoided steamers to decrease service time and costs, leaving the customer with a warm sausage on a cold bun.

Alternatively, other businesses in the food service industry have pre-packaged the sausage and bun in a foil or paper like packaging, thereby providing a ready to eat product. While this alternative saves preparation time and costs by not using a separate steamer, the bun is often left soggy from the direct contact of the sausage on the bun for a prolonged period of time.

Therefore, a need exists for a sausage and bun packaging system that reduces the above-identified inefficiencies and costs of preparing a bun for a food container.

### SUMMARY OF THE INVENTION

The present invention provides a food container for an elongated food item and a bun. The food container includes a base having a bottom wall and defining a longitudinal axis. The food container also includes a cover covering the base above the bottom wall. At least two bun supports are provided on opposite sides of the longitudinal axis and defining a space therebetween for receiving the elongated food item parallel to the longitudinal axis. The bun supports are able to support the bun above the elongated food item.

The present invention also provides a method of cooking a food item using a food container. The method includes positioning a food container in a food heating device. The food container includes a base having a bottom wall and defining a longitudinal axis. The food container also includes a cover covering the base above the bottom wall. At least two bun supports are provided on opposite sides of the longitudinal axis and define a space therebetween for receiving the elongated food item parallel to the longitudinal axis. The bun supports are able to support the bun above the elongated food item. The cover of the food container is above the base when the food container is positioned in the food heating device. The method further includes heating the elongated food item in the food container. The food container is then inverted to allow the open bun to receive the elongated food item.

The foregoing and other objects and advantages of the invention will appear from the following detailed description. In the description, reference is made to the accompanying drawings which illustrate a preferred embodiment of the invention.

### BRIEF DESCRIPTION OF THE DRAWINGS

FIG. 1 is a perspective view of a food container in an open position according to one embodiment of the invention;

FIG. 2 is a perspective view of the food container of FIG. 1 with an elongated food item positioned between bun supports;

FIG. 3 is a perspective view of the food container of FIG. 2 with a bun supported by the bun supports above the elongated food item;

FIG. 4 is a perspective view of the food container of FIG. 3 after the cover has been closed, the container has been inverted to transport the elongated food item into the bun, and the cover has been re-opened such that the bottom of the bun holding the elongated food item is supported;

FIG. 5 is a side cross-sectional view of the food container of FIG. 3 in a closed position;

FIG. 6 is a side cross-sectional view of the food container of FIG. 3 in the closed position with additional supports for the bun and elongated food item;

FIG. 7 is a perspective view of a food container with shelves forming bun supports; and

FIG. 8 is a top view of the open food container of FIG. 7.

### DETAILED DESCRIPTION OF THE INVENTION

The present invention provides a food container for the food service industry. The food container provides a single packaging with bun support members to facilitate steaming the bun indirectly from the steam and moisture of the elongated food item, in comparison to conventional electric steamers and prepackaged foil and paper like containers. Accordingly, costs of preparing a steamed bun for the food container of the present invention are lower in comparison to conventional bun preparation devices. Additionally, the bun support members of the present invention are structured and positioned within the container so that when the bun is placed, food receiving side down, on the bun support members, the elongated food item does not directly contact the bun, thereby inhibiting the bun from becoming soggy.

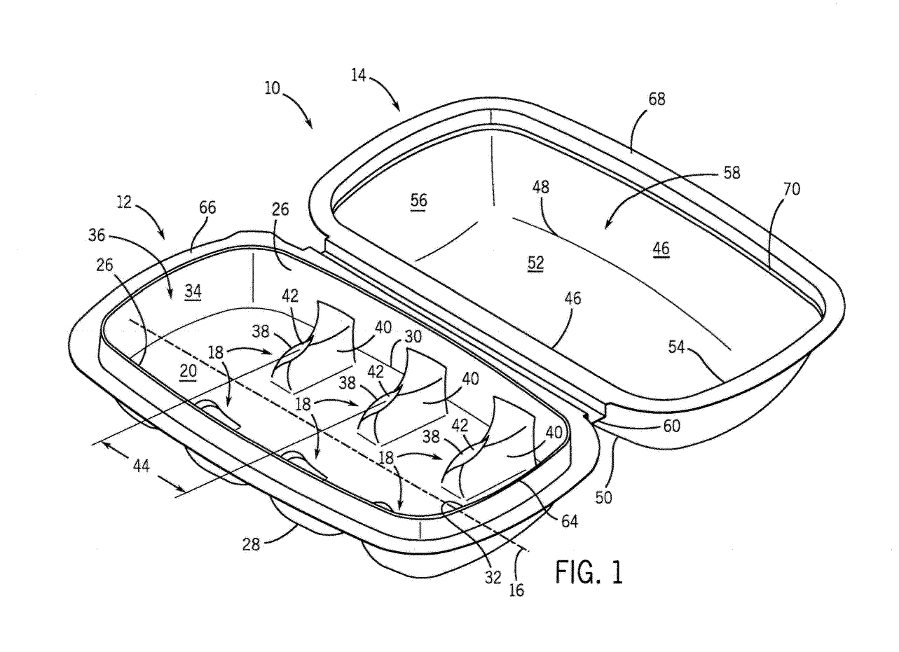

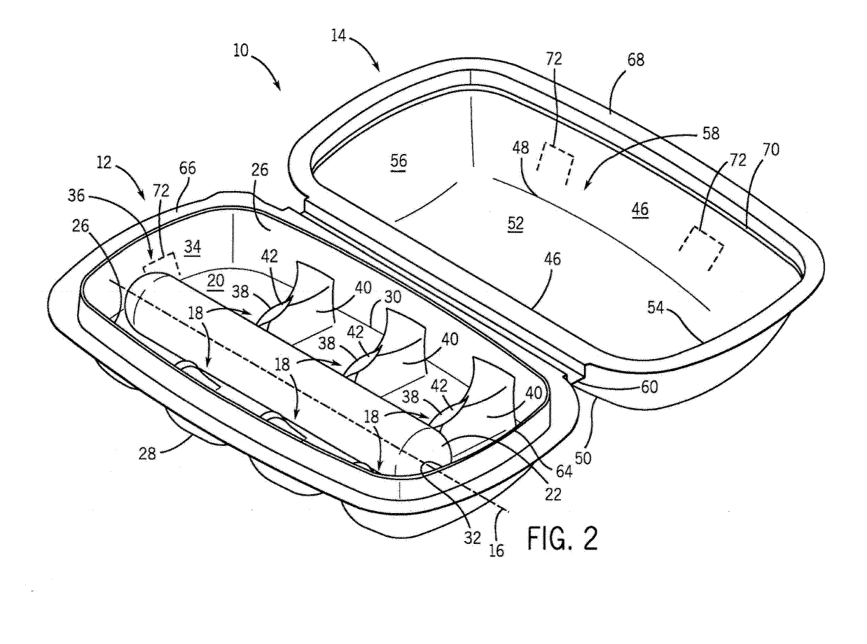

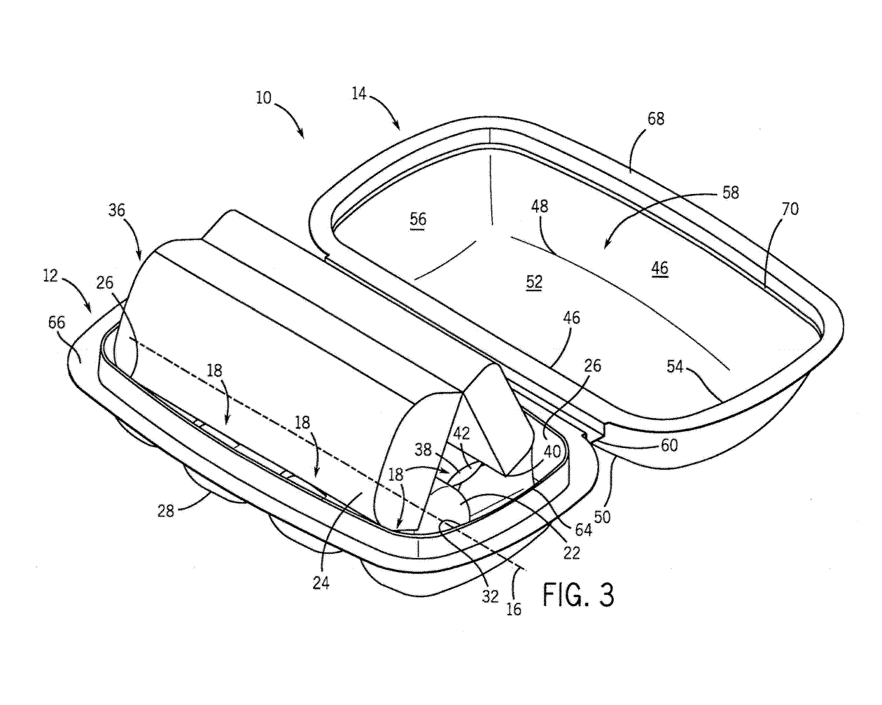

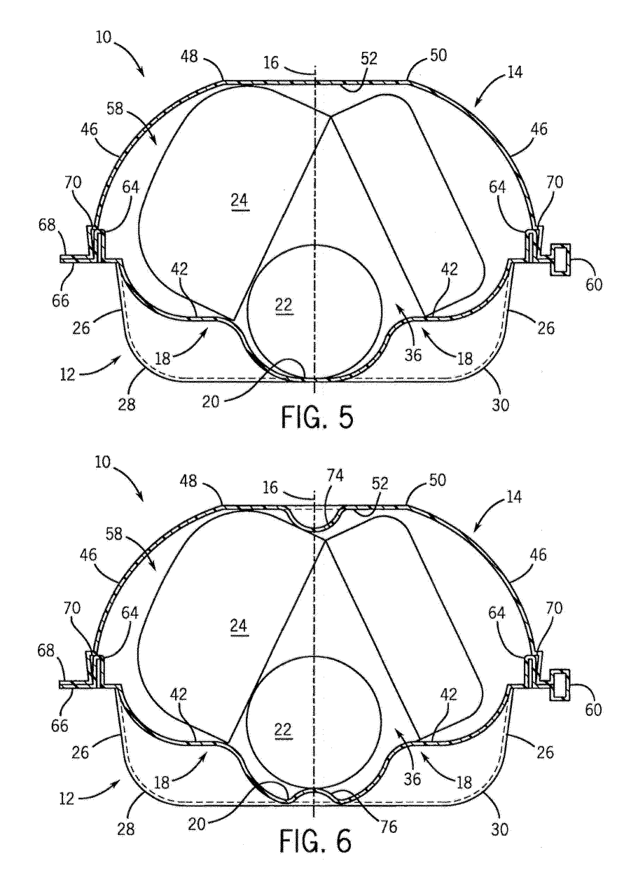

FIGS. 1-6 illustrate a food container 10, according to the present invention, including a base 12 that supports a cover 14. The food container 10 is preferably constructed of a disposable material, such as cardboard, plastic, Styrofoam, or the like. In one preferred embodiment, the food container 10 is constructed of a transparent plastic material allowing a purchaser to see an elongated food item 22 and bun 24 contained therein. The base 12 includes a bottom wall 20 that defines a longitudinal axis 16, and the cover 14 that is positionable relative to the base 12 to cover the base 12 above the bottom wall 20 as illustrated, for example in FIGS. 5 and 6. The food container 10 includes bun supports 18 upwardly extending from the bottom wall 20 of the base 12. The bun supports 18 are configured to receive the elongated food item 22 therebetween with the elongated food item 22 being positioned parallel to the longitudinal axis 16, as shown in FIGS. 2 and 3. The bun supports 18 also provide support for the bun 24, with food receiving side facing down, as shown in FIG. 3, to facilitate steaming of the bun 24 from the moisture and steam from the elongated food item 22.

With further reference to the base 12 of the food container 10, as shown in FIG. 1, a first pair of sidewalls 26 are provided that upwardly extend from a first edge 28 and a second edge 30 of the bottom wall 20 to further secure the elongated food item 22 in the food container 10. The first pair of sidewalls 26 are laterally spaced from the longitudinal axis 16 and, at least in the form illustrated, are formed integrally with the bottom wall 20 of the base 12. The first pair of sidewalls 26 are also integrally formed with a first end wall 32 and a second end wall 34 that upwardly extend from opposite ends of the bottom wall 20, thereby forming an interior volume 36 of the base 12 having a trough-like configuration for receiving the elongated food item 22 and a part of the bun 24.

The bun supports 18 are integrally formed with the bottom wall 20 and provide a guide for placing the open bun 24 in a downwardly open position on top of the bun supports 18. The bun supports 18 are inverted generally V-shaped members, as shown in FIG. 1, each having a first support 38 and a second support 40 integrally coupled at an apex 42. Alternatively, the first support 38 and the second support 40 are joined by a third support (not shown) positioned perpendicular to the first support 38 and the second support 40, thereby forming a platform-type bun support. In yet another alternative embodiment, the bun supports 18 are circular or square shaped posts extending upwardly from the bottom wall 20. The bun supports 18 are positioned on opposite sides of the longitudinal axis 16 and adjacent to the first edge 28 and second edge 30 of the bottom wall 20. In one embodiment, as shown in FIG. 1, three bun supports 18 are positioned along the first edge 28, and three bun supports 18 are positioned along the opposing second edge 30. Any two adjacent bun supports 18 are spaced a distance 44 apart. The positioning and spacing of the bun supports 18 ensures adequate support for the downwardly facing open bun 24 when placed food side down, as illustrated in FIG. 3, so that the bun 24 does not contact the elongated food item 22 and become soggy. In addition, the positioning and spacing of the bun supports 18 inhibits undesired sliding and rolling of the elongated food item 22 in the interior volume 36 of the base 12, as best shown in FIGS. 2 and 5, as portions of the bun supports 18 closest to the longitudinal axis 16 generally maintain the elongated food item 22 positioned along the longitudinal axis 16.

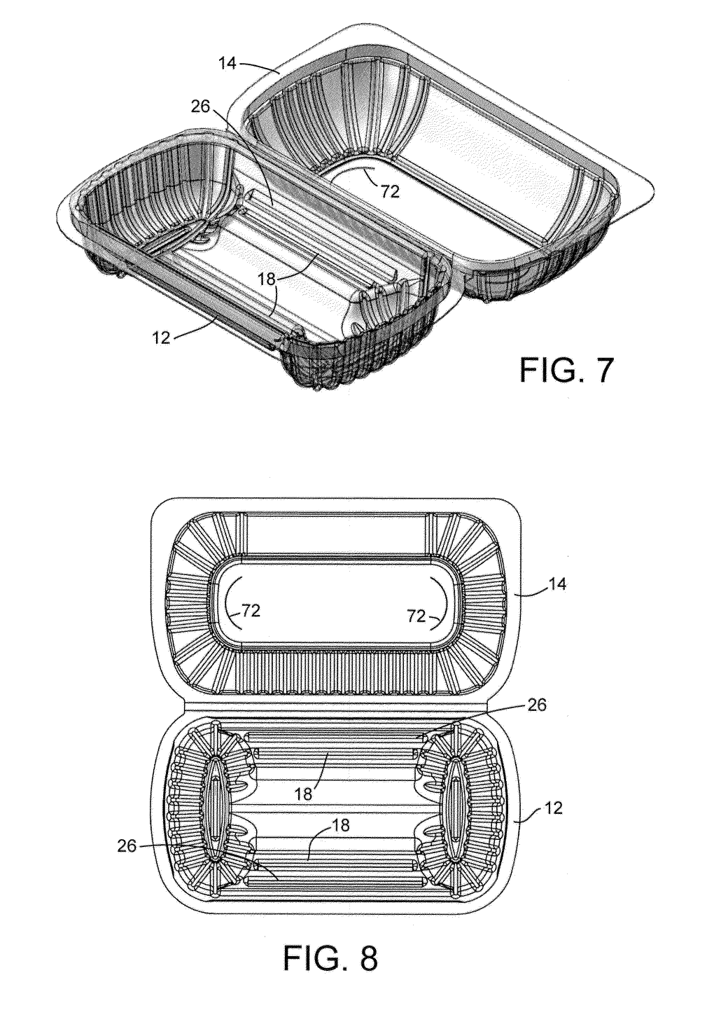

The spacing and positioning of the bun supports 18 shown in FIG. 1 is only exemplary and should not be considered limiting, as the bun supports 18 can be spaced and positioned in other orientations while providing similar functionality. For example, there may be only two bun supports 18 positioned on the second edge 30, and one bun support 18 positioned along the first edge 28. The two bun supports 18 positioned on the second edge 30 are spaced a distance 44 apart, as previously described, and the single bun support 18 can be positioned along the first edge 28 between the distance 44. This effectively creates three points of support for the bun 24, defining a support plane. Alternatively, two of the bun supports 18 might be positioned on both the first edge 28 and the second edge 30 to provide adequate support for the bun 24 and limited movement of the elongated food item 22. In yet another embodiment, the bun supports 18 may be shelves extending inwardly from the first pair of sidewalls 26 and extend at least along a portion of the length of the base 12 or cover 14, such as shown in FIGS. 7 and 8.

With further reference to the cover 14, as best shown in FIGS. 1 and 2, a second pair of sidewalls 46 are provided that extend upwardly from a third edge 48 and a fourth edge 50, respectively, of a top wall 52. The second pair of sidewalls 46 are integrally formed with the top wall 52 of the cover 14. The second pair of sidewalls 46, the third edge 48, and the fourth edge 50 are parallel to the longitudinal axis 16 that extends the length of the food container 10, as best shown in FIG. 5. The second pair of sidewalls 46 are also formed integral with a third end wall 54 and an opposing fourth end wall 56, thereby forming a receiving area 58 having a trough-like configuration for receiving the bun 24 and elongated food item 22, as will be described in further detail below.

The base 12 and the cover 14 are joined by a hinge 60 that connects a peripheral flange 66 of the base 12 and a mating peripheral flange 68 of the cover 14. Although the integral hinge 60 is illustrated and in many instances preferred to keep the base 12 and cover 14 together, any suitable coupling mechanism can be used to rotate the cover 14 from an open position, as shown in FIG. 1, to a closed position as shown in FIG. 5. Still yet, it is contemplated that the coupling mechanism might be omitted and the base 12 and cover 14 coupled by the mating flanges 66 and 68 or other engaging portions of the two sections, particularly if the flanges are formed with one or more deformable locking elements that effectively snap the portions together. As illustrated, the peripheral flange 66 of the base 12 includes an upwardly extending peripheral lip 64 that is received by a mating ledge 70 of the cover 14 when the food container 10 is in a closed position, as shown in FIG. 5. The mating ledge 70 extends along the inside perimeter of the cover 14 and engages the peripheral lip 64 to snap fit the cover 14 to the base 12. The snap-fit closing mechanism permits the elongated food item 22 and bun 24 to remain warm and fresh in the relatively air-tight food container 10.

Alternatively, to secure the food container 10 closed, a slit may be positioned on the peripheral flange 66 of the base 12 and configured to receive a flap that is coupled to the peripheral flange 68 of the cover 14. When the cover 14 is rotated about the hinge 60 to close the food container 10, the flap is received by the slit. The slit and the flap may be centrally positioned along the peripheral flanges 66 and 68, respectively, on edges opposite the hinge 60.

In an alternative embodiment, as shown in FIG. 2, knock-outs 72 are built into the cover 14; however, the knock-outs 72 may also be built into the base 12. The knock-outs 72 begin as perforated seals in the cover 14 or base 12. Prior to heating the elongated food item 22, the knock-outs 72 are pressed either inwardly or outwardly by a user to break the perforated seals. Thus, vents are provided to release heat, moisture or any excess drainage from the food container 10 as the elongated food item 22 is cooked. Alternatively, vents 72 can be provided as slits die cut into the cover 14 or base 12, as shown in the form illustrated in FIG. 8.

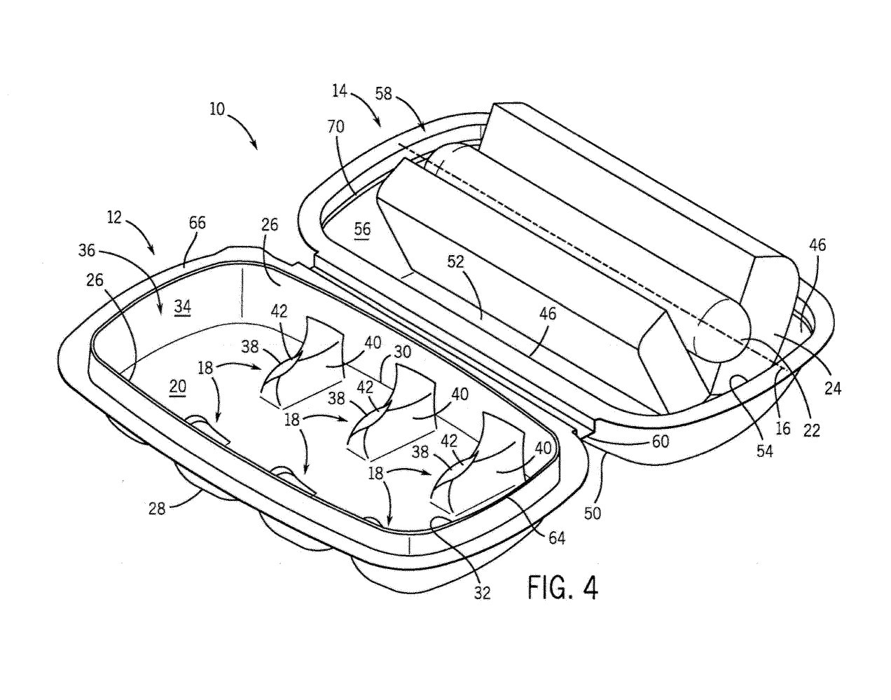

In yet another embodiment, as shown in FIG. 6, a bun holder 74 is provided. The bun holder 74 is coupled to and extends the length of the top wall 52 of the cover 14. The bun holder 74 is parallel to the longitudinal axis 16 and is configured to provide additional support for the bun 24 as the food container 10 is handled. Thus, as the food container 10 is inverted from the position as shown in FIG. 6, the bun 24 will remain in a suitable position to receive the elongated food item 22, as shown in FIG. 4. The bun holder 74 further inhibits the bun 24 from falling into the base 12 of the food container 10. Alternatively, separate bun holders 74 that do not extend the length of the top wall 52, may be coupled to the top wall 52 adjacent the third and fourth end walls 54 and 56.

A lower support 76 is also provided in the embodiment shown in FIG. 6. The lower support 76 is coupled to and extends the length of the bottom wall 20 of the base 12. The lower support 76 is parallel to the longitudinal axis 16 and is configured to position the elongated food item 22 above the bottom wall 20. Thus, any excess water or drainage from the elongated food item 22 can be drained from the food container 10 through one of the knock-outs 72 positioned on the base 12, as shown in FIG. 2. This configuration allows the food container 10 to be inverted from the position as shown in FIGS. 5 and 6 without soaking the bun 24 with the excess water and drainage from heating the elongated food item 22. Alternatively, separate lower supports 76 that do not extend the length of the bottom wall 20, may be coupled to the bottom wall 20 adjacent the first and second end walls 32 and 34.

During operation, the elongated food item 22 is cooked, and then placed into the interior volume 36 of the base 12, in between the bun supports 18 along the longitudinal axis 16, as shown in FIG. 2. The elongated food item 22 may be a meat product, for example a sausage, bratwurst, or hotdog. Alternatively the elongated food item 22 may be a non-meat product, for example a vegetarian sausage, bratwurst or hotdog. While the elongated food item 22 is still warm and steaming, the bun 24 is placed, food side down, on top of the bun supports 18, as shown in FIG. 3. Advantageously, the elongated food item 22 steams the bun 24 without directly contacting the bun 24, as shown in FIG. 5, thereby inhibiting the bun 24 from getting soggy. The cover 14 is then rotated about the hinge 60 to close the food container 10, as shown in FIG. 5.

The knock-outs 72, if available, may be knocked out to release some of the heat and moisture from the food container 10. The food container 10 is placed into a food heating device, such as a food warmer, to keep the elongated food item 22 and bun 24 warm prior to serving. As the elongated food item 22 is heated in the food container 10, water contained in the elongated food item 22 is also heated to steam the bun 24. Once the elongated food item 22 and bun 24 are ready to be served to a consumer, for example, the consumer inverts the food container 10 about the longitudinal axis 16 180 degrees in either a clockwise or counterclockwise direction. In other words, the food container 10 may be flipped to an upside down position with respect to the position shown in FIG. 5 such that the cover 14 is positioned underneath the base 12. The flipping motion of the food container 10 causes the elongated food item 22 to fall into the bun 24 in the receiving area 58 of the cover 14, as shown in FIG. 4. The consumer may open the food container 10 and retrieve the elongated food item 22 and, now steamed, bun 24 for consumption.

While there has been shown and described what are at present considered the preferred embodiments of the invention, it will be obvious to those skilled in the art that various changes and modifications can be made therein without departing from the scope of the invention defined by the appended claims.

We claim:

1. A food container comprising:
a base having a bottom wall and defining a longitudinal axis;
a cover positionable to cover the base above the bottom wall;
at least two bun supports on opposite sides of the longitudinal axis and defining a space therebetween for receiving an elongated food item substantially parallel to the longitudinal axis, wherein the bun supports are positioned to support a bun above the elongated food item.

2. The food container as in claim 1, in which the base includes sidewalls laterally spaced from the longitudinal axis, wherein at least one of the at least two bun supports is spaced inwardly from the sidewalls towards the longitudinal axis.

3. The food container as in claim 2, in which the at least one of the at least two bun supports extends upwardly from the bottom wall.

4. The food container as in claim 1, in which the cover is hingedly connected to the base.

5. The food container as in claim 1, in which the at least two bun supports are shelves extending inwardly from the opposite sides.

6. The food container as in claim 1, in which at least one of the cover and the base includes at least one vent.

7. The food container as in claim 6, in which the at least one of the cover and the base includes at least one knock-out, which can be knocked out to form the at least one vent prior to heating the elongated food item in the food container.

8. The food container as in claim 1, further including an elongated food item disposed in the space between the at least two bun supports, and a downwardly opening open bun supported by the at least two bun supports above the elongated food item, wherein upon inverting the food container, the elongated food item is received into the open bun.

9. The food container as in claim 8, in which the elongated food item is a meat product.

10. The food container as in claim 1, including a bun holder coupled to the cover and extending substantially parallel to the longitudinal axis, wherein the bun holder is positioned to restrict movement of the bun in the food container.

11. The food container as in claim 1, including a lower support coupled to the bottom wall and extending substantially parallel to the longitudinal axis, wherein the lower support elevates the elongated food item above the bottom wall.

12. A method of cooking a food item, the method comprising:
positioning the food container of claim 1 in a food heating device with the cover above the base;
heating the elongated food item in the food container;
inverting the food container allowing an open bun to receive the elongated food item.

13. The method as in claim 12, in which the elongated food item contains water, and heating the elongated food item heats the water to steam the bun.

14. The method as in claim 12, including forming vents in the container prior to heating the elongated food item in the food container.
